(19) United States
(12) Patent Application Publication
(10) Pub. No.: US 2014/0220392 A1
(43) Pub. Date: Aug. 7, 2014

(54) Prussian Blue Analogue Anodes for Aqueous Electrolyte Batteries

(71) Applicant: Alveo Energy, Inc., Palo Alto, CA (US)

(72) Inventors: Colin Deane Wessells, Palo Alto, CA (US); Robert Alan Huggins, Stanford, CA (US)

(73) Assignee: ALVEO ENERGY, INC., Palo Alto, CA (US)

(21) Appl. No.: 13/904,874

(22) Filed: May 29, 2013

Related U.S. Application Data
(60) Provisional application No. 61/760,402, filed on Feb. 4, 2013.

(51) Int. Cl. H01M 4/58

(52) U.S. Cl. CPC H01M 4/58
USPC 429/50; 429/231.8; 429/231.6; 429/231.5; 429/224; 429/221; 429/223; 429/220; 429/229; 429/225; 252/182.1

(57) ABSTRACT

A system and method producing electrodes in an aqueous electrolyte battery that maximizes energy storage, reduces electrochemical decomposition of the electrolyte, and uses Prussian Blue analogue materials for both electrodes, with an anode electrode including an electrochemically active hexacyanometalate group having two possible redox reactions of different potentials. These potentials may be tuned by substituting different electrochemically inactive components.

### CROSS REFERENCE TO RELATED APPLICATIONS

This application claims benefit of U.S. Patent Application No. 61/760,402 filed 4 Feb. 2013, the contents in its entirety thereof expressly incorporated by reference thereto for all purposes.

### FIELD OF THE INVENTION

The present invention relates generally to Prussian Blue anodes for use in an aqueous battery, and more specifically, but not exclusively, to specific tunable Prussian Blue analogue electrodes including Prussian Blue analogue anodes.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

In recent years a variety of battery technologies have been explored and developed for portable and stationary applications. These include lead acid, lithium ion, nickel/metal hydride, sodium sulfur, and flow batteries, among others. Unfortunately, not one of these technologies provides a sufficiently low cost, long enough cycle life, high enough rate capability, or high enough energy efficiency to provide useful energy storage and power for short-term, transient stationary storage applications. This includes a mitigation of costly transients on the electric grid, short term back up power and load management, regulatory services, and the deferral of investments in other power grid infrastructure components. Batteries may also support off-grid stationary electronic systems, whether by providing short-term backup power, or for facilities not connected to larger grids. Another large, unfulfilled market for batteries is the microhybrid, or stop-start automotive battery. The lead acid batteries currently used for this application must be significantly oversized to avoid destruction due to repeated high rate deep discharge, resulting in heavy, expensive systems.

Conventional battery electrode materials cannot survive for the sufficient deep discharge cycles that need to be used for the transient applications related to the electric grid or microhybrid vehicles. Additionally, a rate capability is of these conventional electrode materials is also limited by poor kinetics for ion transfer and diffusion or by the formation of new material phases.

The use of Prussian Blue analogues, which are transition metal cyanides of the general formula AxPy[R(CN)6]z.nH2O (A=alkali cation, P and R=transition metal cations, 0≦x≦2, 0≦y≦4, 0≦z≦1, 0≦n) as battery electrode materials in an aqueous electrolyte battery has been published. These electrodes are described as having longer cycle life, faster kinetics, and higher energy efficiency than any other family of electrodes when operated in aqueous electrolytes. Nearly all disclosed Prussian Blue analogues contain electrochemically active iron, which has a high electrochemical potential, and which therefore makes those materials suitable as cathodes only. Without an anode having comparably long cycle life and high rate capability, the performance advantages of a Prussian Blue analogue cathode are lost in a full battery.

For example, US Application Publication No. 2012/0328936, published 27 Dec. 2012, includes a discussion of inventions addressing short term high power requirements, particularly concepts concerning HIGH RATE, LONG CYCLE LIFE BATTERY ELECTRODE MATERIALS WITH AN OPEN FRAMEWORK STRUCTURE that includes Prussian Blue analogues. This publication is hereby expressly incorporated by reference in its entirety for all purposes.

While the prior art may have described the use of Prussian Blue analogues electrodes in an aqueous electrolyte battery, specifics about manufacturing and use of actual electrodes are largely limited to cathodes. The extension of the general principles of Prussian Blue analogue cathodes is, in some important respects, prophetic and based upon an incomplete understanding of practical implications of actual Prussian Blue anodes in an aqueous electrolyte battery.

In a practical aqueous electrolyte battery, electrolysis is a constraint on selection of electrode material. Depending upon many factors, electrochemical decomposition of the electrolyte produces oxygen gas and hydrogen gas which can be dangerous in many situations. There is a tension in battery design in that the greater difference between the relative potentials between the electrodes the more energy may be stored while a too great potential at the cathode relative to a standard hydrogen electrode produces oxygen gas and a too low potential of the anode relative to the standard hydrogen electrode produces hydrogen gas, these being independent and related to the particular material of each specific electrode.

There are examples where researchers have used Prussian Blue analogues as battery electrodes. Prussian Blue analogues have been used as anodes and cathodes in cells containing aqueous and organic electrolytes. For example, the reversible reduction of Prussian Blue to Everitt's Salt has allowed its use as an anode in aqueous cells. However, the reduction potentials of Prussian Blue is relatively high, so using it as an anode along with a Prussian Blue analogue cathode results in a low full cell voltage of 0.5-0.7 V. Such low voltages make these cells impractical, as many cells in series are required to achieve the voltages needed for many applications, particularly in the case of high voltage applications.

Chromium hexacyanochromate (CrHCCr) has also been used as an anode in full cells that also contained Prussian Blue cathodes, and an aqueous/Nafion electrolyte. The performance of these cells was limited by the low potential and poor coulombic efficiency of CrHCCr in aqueous electrolytes and the use of acidic electrolytes in which CrHCCr hydrolyzes.

Prussian Blue analogues have also been used as cathodes, but not as anodes, in organic electrolyte batteries. Most commonly, they have been used as cathodes in place of the standard LiCoO2 cathode found in high-voltage organic electrolyte Li-ion cells. A number of studies have demonstrated Prussian Blue analogues containing electrochemically active iron and/or manganese as cathodes in these high voltage cells.

What is needed is a system and method producing electrodes in an aqueous electrolyte battery that maximizes energy storage, reduces electrochemical decomposition of the electrolyte, and uses Prussian Blue analogue materials for both electrodes.

### BRIEF SUMMARY OF THE INVENTION

Disclosed is a system and method producing electrodes in an aqueous electrolyte battery that maximizes energy storage, reduces electrochemical decomposition of the electrolyte, and uses Prussian Blue analogue materials for both electrodes.

The following summary of the invention is provided to facilitate an understanding of some of technical features related to secondary Prussian Blue analogue electrode aqueous electrolyte batteries, and is not intended to be a full description of the present invention. A full appreciation of the various aspects of the invention can be gained by taking the entire specification, claims, drawings, and abstract as a whole. The present invention is applicable to other battery designs including batteries containing organic electrolytes.

Described are new Prussian Blue analogue anodes in which iron has been replaced with other electrochemically active species that have much lower reaction potentials. This allows the construction of symmetric full batteries containing a Prussian Blue analogue cathode and a Prussian Blue analogue anode having low reaction potentials near the lower limit of the electrochemical stability of aqueous electrolytes. These new anode materials have multiple reaction potentials, and that by controlling their chemical composition, their reaction potentials can be tuned to attractive values.

Also described is use of hexacyanomanganate (HCMn) based Prussian Blue analogues as anodes in batteries that also contain aqueous electrolytes. Previously published scientific literature indicates that that these materials undergo two electrochemical reactions, an upper reaction and a lower reaction. Only the upper reaction has previously been used as a battery anode. The upper reaction corresponds to an oxidation/reduction of Mn3+/Mn2+, while the lower reaction corresponds to an oxidation/reduction of Mn2+/Mn+. The upper reaction is analogous to the Fe3+/Fe2+ reaction that occurs in Prussian Blue analogue cathodes documented in previous patent literature. The lower reaction occurs by a novel mechanism not observed in the iron-based cathodes.

Further described are multiple types of tuning. A first type of tuning (e.g., raising or lowering) the reaction potentials of the anode by selecting the electrochemically inactive metals in the structure to allow successful use of this lower reaction in aqueous electrolytes without catastrophic water hydrolysis. A second type of tuning includes adjusting the reaction potentials of the anode with new compositions to adjust the potential of its upper reaction to raise the battery voltage.

Also further described is use of mildly acidic/neutral electrolytes for these battery electrodes, as well as the combination of different insertion ions for the two electrodes.

Embodiments of the present invention include structures and materials that produce potentials falling into ranges that require a careful choice of electrode composition using the principles described here. Disclosed embodiments include not only a novel use of a lower reaction of an anode, but also the use of the upper reaction when it is shifted to a more favorable potential. The embodiments provide the battery designer with more options for manufacture of an actual secondary high rate long cycle life the aqueous electrolyte battery.

Some embodiments include a commercially viable battery (cell) that comprises an aqueous electrolyte and two electrodes (an anode and a cathode), one or both of which is a Prussian Blue analogue material of the general chemical formula AxP[R(CN)6-1L1]z.nH2O, where:

A is a monovalent cation such as Na+, K+, Li+, or NH4+, or a divalent cation such as Mg2+ or Ca2+, and combinations thereof;

P is a transition metal cation such as Ti3+, Ti4+, V2+, V3+, Cr2+, Cr3+, Mn2+, Mn3+, Fe2+, Fe3+, Co2+, Co3+, Ni2+, Cu+, Cu2+, or Zn2+, or another metal cation such as Al3+, Sn2+, In3+, or Pb2+, and combinations thereof;

R is a transition metal cation such as V2+, V3+, Cr2+, Cr3+, Mn2+, Mn3+, Fe2+, Fe3+, Co2+, Co3+, Ru2+, Ru3+, Os2+, Os3+, Ir2+, Ir3+, Pt2+, or Pt3+, and combinations thereof;

L is a ligand that may be substituted in the place of a CN— ligand, including CO (carbonyl), NO (nitrosyl), or Cl—, and combinations thereof;

0<=x<=2;

0<=z<=1;

0<=n<=5.

Any of the embodiments described herein may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

Other features, benefits, and advantages of the present invention will be apparent upon a review of the present disclosure, including the specification, drawings, and claims.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a unit cell of a face-centered cubic crystal structure for Prussian Blue;

FIG. 2 illustrates a graph of a cyclic voltammetry of ZnHCMn and MnHCMn;

FIG. 3 illustrates a chart of an X-ray diffraction of ZnHCMn synthesized in air and N2;

FIG. 4 illustrates a graph of a cyclic voltammetry of ZnHCMn in Na+ and K+ electrolytes;

FIG. 5 illustrates a schematic of batteries using upper and lower anode reactions;

FIG. 6 illustrates a demonstration of efficient, reversible cycling of ZnHCMn(II/I);

FIG. 7 illustrates a graph of cyclic voltammetry of ZnHCMn(II/I) showing an increased potential in more concentrated electrolyte salt;

FIG. 8 illustrates a galvanostatic cycling of ZnHCMn with K+;

FIG. 9 illustrates a galvanostatic cycling of a full CuHCF vs ZnHCMn(II/I) secondary battery; and

FIG. 10 illustrates a schematic of increasing battery voltage using different insertion ions for the anode and cathode.

### DETAILED DESCRIPTION OF THE INVENTION

Embodiments of the present invention provide a system and method producing electrodes in an aqueous electrolyte battery that maximizes energy storage, reduces electrochemical decomposition of the electrolyte, and uses Prussian Blue analogue materials for both electrodes. The following description is presented to enable one of ordinary skill in the art to make and use the invention and is provided in the context of a patent application and its requirements.

Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

A battery (or cell) comprises an anode, a cathode, and an electrolyte that is in contact with both the anode and the cathode. Both the cathode and the anode contain an electrochemically active material that may undergo a change in valence state, accompanied by the acceptance or release of cations and electrons. For example, during discharge of a battery, electrons are extracted from the anode to an external circuit, while cations are removed from the anode into the electrolyte. Simultaneously, electrons from the external circuit enter the cathode, as do cations from the electrolyte. The difference in the electrochemical potentials of the cathode and anode results in a full cell voltage. This voltage difference allows energy to be extracted from the battery during discharge, or stored in the battery during charge.

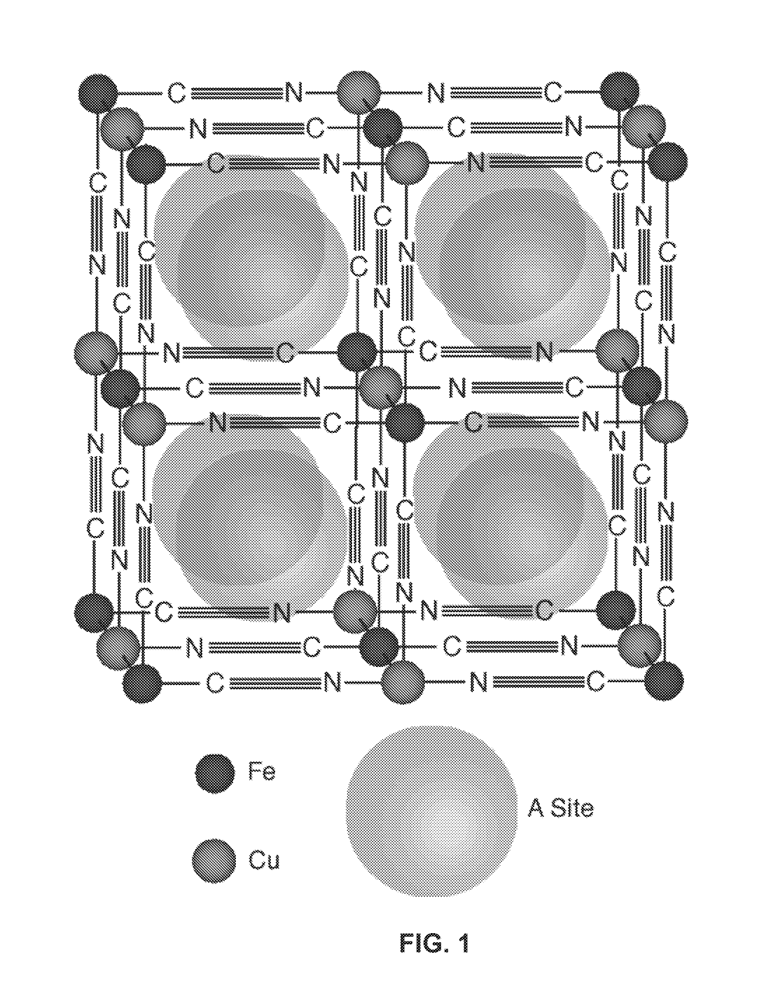

Prussian Blue is a well-known material phase of iron cyanide hydrate of the general chemical formula KxFeIII[FeII(CN)6]z.nH2O (0≦x, z≦1; n≈4). This material has been produced industrially for centuries for use as a pigment and dyestuff. It is also a well-known electrochromic material, and has been studied for use as a cathode in electrochromic displays. FIG. 1 illustrates a structure of Prussian Blue having a face-centered cubic crystal structure. In this structure, cyanide bridging ligands link transition metal cations in a spacious open framework. The structure contains large interstitial sites commonly called the “A Sites.” Each unit cell contains eight A Sites, each of which may contain zeolitic water, interstitial alkali cations, or both.

For example, copper hexacyanoferrate (CuHCF) is a Prussian Blue analogue recently demonstrated to be a high performance battery electrode. In the open framework structure of CuHCF, iron is six-fold, octahedrally coordinated to the carbon ends of the cyanide branching ligands, while copper is octahedrally nitrogen-coordinated. Depending on the method of synthesis, the A sites in CuHCF may contain potassium or another alkali cation such as sodium or lithium, or another type of cation such as ammonium. More generally, for a Prussian Blue analogue of the general chemical formula AxPy[R(CN)6]z.nH2O, alkali cations A+ and water occupy the interstitial A Sites, transition metal P cations are six-fold nitrogen coordinated, and transition metal R cations are six-fold carbon coordinated.

Electrochemical cells used to test electrode properties contained a Prussian Blue analogue working electrode, a counter electrode, an electrolyte in contact with both the anode and cathode, and a Ag/AgCl reference electrode used to independently measure the potentials of the anode and cathode during charge and discharge of the cell. When the electrode of interest was a cathode material, then the working electrode was the cathode, and the counter electrode was the anode. When the electrode of interest was an anode material, then the working electrode was the anode, and the counter electrode was the cathode. In the case that the cell did not contain both a Prussian Blue analogue cathode and a Prussian Blue analogue anode, a capacitive activated charcoal counter electrode was used to complete the circuit while allowing the study of a single Prussian Blue analogue electrode.

Several measurement and characterization techniques were used to examine the materials and electrodes described here. Physical characterization of Prussian Blue analogue materials was performed using X-ray diffraction (XRD) and scanning electron microscopy (SEM). Electrochemical characterization of electrodes was performed using galvanostatic cycling with potential limitation (GCPL). During the GCPL technique a constant current is applied to the cell until the working electrode reaches a maximum or minimum potential; upon reaching this potential extreme, the sign of the current is reversed.

Embodiments of the present invention include the use of Prussian Blue analogues containing electrochemically active hexacyanomanganate groups as anodes in aqueous electrolyte batteries. The electrochemical activity of these materials was briefly examined many years ago. However, those simple electrochemical tests did not lead to their use as anode materials in batteries.

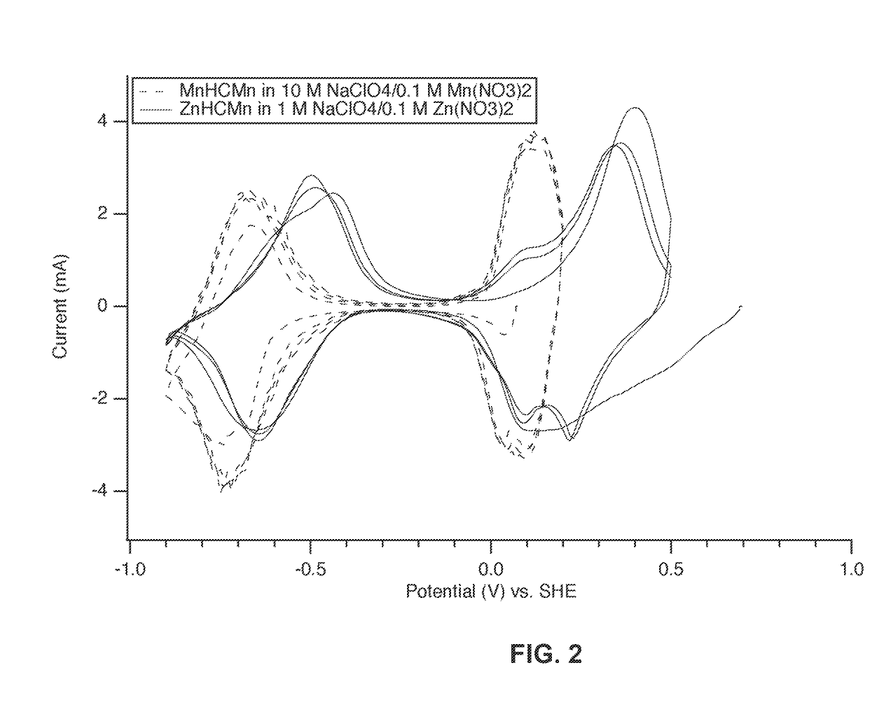

That hexacyanomanganate-based Prussian Blue analogues can be used as anode materials is not obvious for several reasons. First, many manganese-based compounds will hydrolyze in water, decomposing into manganese oxides or hydroxides. This is the case for the hexacyanomanganate anion used as a precursor during synthesis of these materials, so producing them in pure form is challenging. Second, the known hexacyanomanganate-based Prussian Blue analogues undergo two electrochemical reactions (Mn3+/Mn2+, and presumably, Mn2+/Mn+), as shown in FIG. 2, but for most known hexacyanomanganate-based Prussian Blue analogues, these reactions occur at either a relatively high potential that results in a low cell voltage, or at too low a potential to avoid simultaneous reduction of water to H2. The one known exception to this case is chromium hexacyanomanganate (CrHCMn), which has a lower reaction at a desirable potential, but during the course of this work, CrHCMn was found to be extraordinarily difficult to synthesize in pure form due to the rapid formation of hydroxides and simple cyanides of the Cr2+ precursor needed for its synthesis. Third, physical characterization studies have demonstrated that the manganese-carbon bond in the hexacyanomanganate complex is more labile than the analogues bonds in other hexacyanometalate complexes, which suggests that these materials could not survive operation as battery electrodes before decomposing.

The disclosed embodiment demonstrate that with the correct choice of a P-site transition metal cation, the reaction potentials of hexacyanomanganate-based Prussian Blue analogues can be tuned to desired values without sacrificing materials stability or purity. The model material demonstrating this is zinc hexacyanomanganate (ZnHCMn), which until now has been unknown as a specifically identified, manufactured, and tested material. This is believed to be the first actual synthesis of this material, let alone a use of it as a battery electrode. ZnHCMn is the model for a new family of hexacyanomanganate-based Prussian Blue analogue anodes.

Materials Synthesis Methods:

CuHCF was synthesized as reported previously in one or more of the incorporated references, for example Wessells, C. D., et al. Copper hexacyanoferrate battery electrodes with long cycle life and high power. Nature Comm., 2, 550 (2011). An aqueous solution of Cu(NO3)2, and a second aqueous solution of K3Fe(CN)6 were added to water by simultaneous, dropwise addition while stirring. The final concentrations of the precursors were 40 mM Cu(NO3)2 and 20 mM K3Fe(CN)6. A solid, brown precipitate formed immediately. It was filtered or centrifuged, washed, and dried. In a prior study, CuHCF synthesized by this method was found to have the composition K0.7Cu[Fe(CN)6]0.7.2.8H2O. The CuHCF was found to have the cubic Prussian Blue open framework crystal structure using XRD. The CuHCF was composed of nanoparticles about 50 nm in size, as verified by SEM.

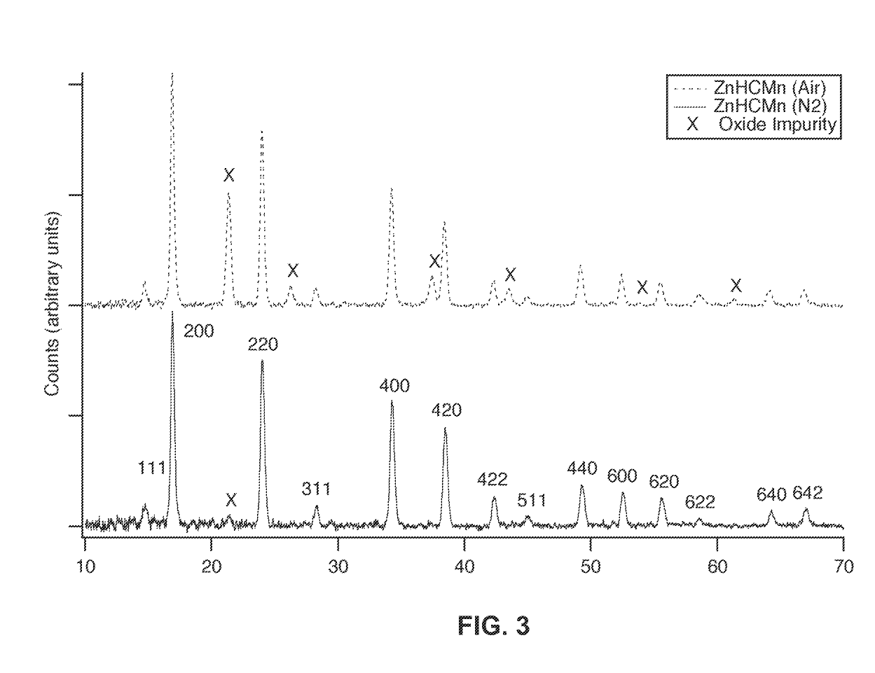

ZnHCMn was synthesized by adding 0.001 mol K3Mn(CN)6 powder to 20 mL of a concentrated aqueous solution containing 0.002 mol Zn(NO3)2, resulting in the rapid precipitation of a pink powder which could be visually distinguished from any remaining unreacted K3Mn(CN)6 by its less orange hue. Various syntheses using Zn2+ precursor solutions of concentrations from 1 M to saturation resulted in little difference in particle crystallinity. This was true even in the limiting case of combining powders of the two precursors and then adding only enough water for them to partially dissolve while grinding them together. Analysis of powder X-ray diffraction of freshly synthesized ZnHCMn revealed that it has the face-centered cubic Prussian Blue structure with a lattice parameter of 10.44 Å as illustrated by FIG. 3.

To synthesize ZnHCMn with high purity, the synthesis must be anaerobic. When air was present during the synthesis, an oxide impurity phase was observed as seen in FIG. 3. Furthermore, [Mn(CN)6]3− is known to suffer light-catalyzed decomposition and disproportionation, so the synthesis of ZnHCMn should occur in low light or dark conditions. After synthesis, the ZnHCMn powder was centrifuged, washed with methanol to remove residual salts, and dried under an anaerobic atmosphere of 98% N2/2% H2. During processing, the ZnHCMn was not exposed to air or oxygen. It was stored in an opaque container.

Manganese hexacyanomanganate (MnHCMn) was synthesized by two different methods. First, MnHCMn was synthesized using a procedure analogous to the one used to produce ZnHCMn. In a dark, anaerobic environment, 0.001 mol K3Mn(CN)6 powder was added to 20 mL of aqueous 1 M Mn(NO3)2. A light brown precipitate formed immediately. All further processing steps were the same as for ZnHCMn.

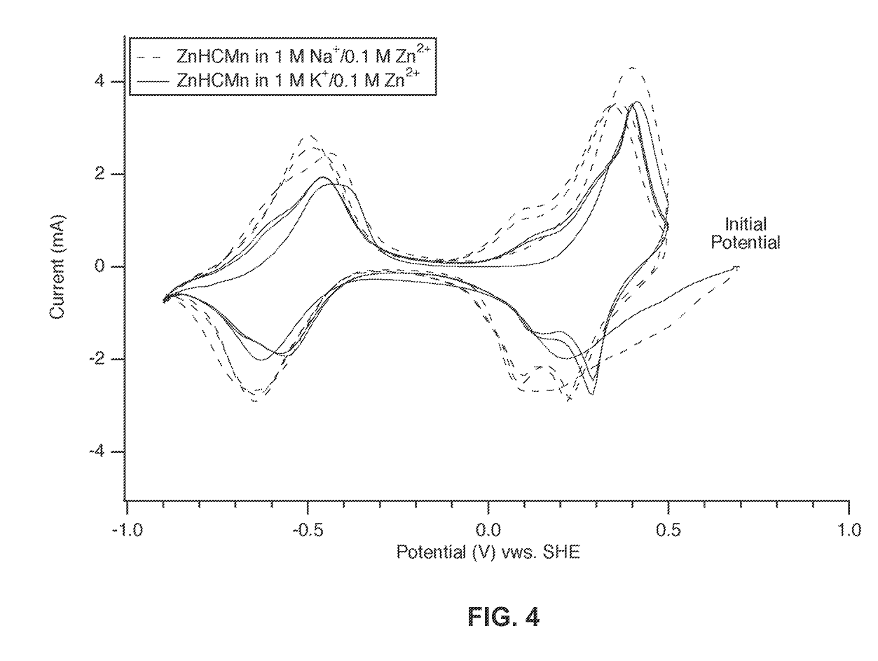

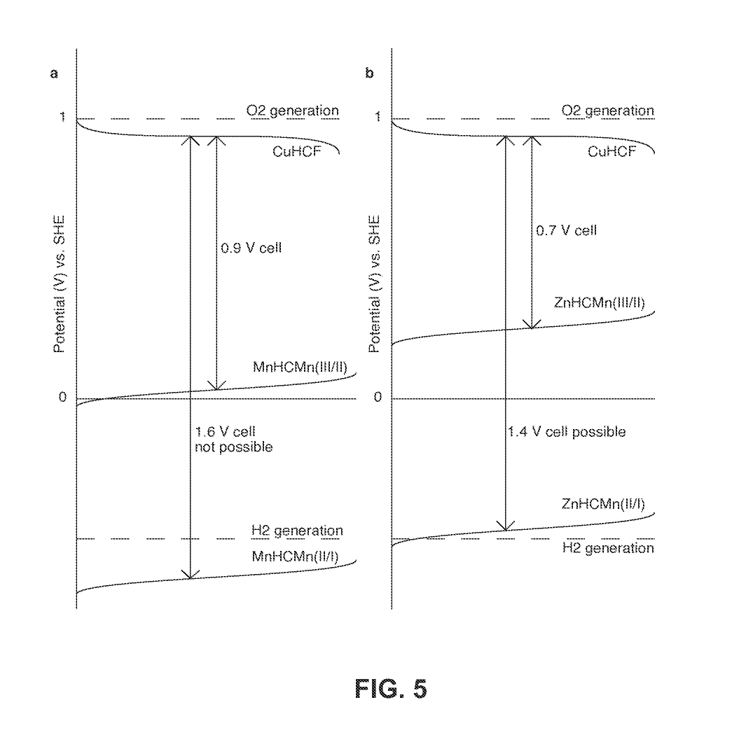

The second method used to produce MnHCMn is a single-step procedure similar to one reported in Asakura, D., et al. Fabrication of a Cyanide-Bridged Coordination Polymer Electrode for Enhanced Electrochemical Ion Storage Ability. J. Phys. Chem. C, 116, 8364 (2012). A 10 mL aqueous solution containing 0.5 g KCN was slowly added to a 10 mL aqueous solution containing 0.5 g of MnCl2 in a N2 atmosphere. A dark green precipitate slowly formed. This precipitate was centrifuged, washed, and dried with no exposure to air or oxygen. X-ray diffraction of the freshly synthesized material revealed a monoclinic structure indicative of a slight distortion to the standard Prussian Blue open framework structure illustrated in FIG. 4. After partial oxidation, the cubic phase was found to form. This result indicates an approximate chemical formula K2MnII[MnII(CN)6].nH2O. SEM showed that the MnHCMn was composed of 1-5 μm agglomerations of 200-1000 nm particles illustrated in FIG. 5.

Aqueous electrolytes were prepared from reagent-grade salts such as KNO3 or NaClO4 and de-ionized water. These alkali salt electrolytes are typically pH-neutral. For cases in which the electrolytes were acidified, the pH was lowered using HNO3.

Electrodes containing the freshly synthesized Prussian Blue analogues were prepared as reported previously in one or more of the incorporated references, for example Wessells, C. D., et al. Copper hexacyanoferrate battery electrodes with long cycle life and high power. Nature Comm., 2, 550 (2011). The electrochemically active material, carbon black, and polyvinylidene difluoride (PVDF) binder were ground by hand until homogeneous, and then stirred in 1-methyl-2-pyrrolidinone (NMP) solvent for several hours. This slurry was deposited on electronically conductive substrates such as aluminum foil or carbon cloth using a doctor blade or spatula. These electrodes were dried in vacuum or a N2 atmosphere at 60° C.

Activated charcoal counter electrodes were prepared by grinding the charcoal with PVDF before stirring in NMP for several hours, followed by deposition and drying on conductive substrates following the same procedure as in the case of electrodes containing a Prussian Blue analogue.

Typical electrolytes contained 1 M NaNO3 or KNO3, where Na+ or K+ was the insertion species during electrochemical cycling of the working electrode. In addition, 0.1 M Mn(NO3)2 and/or 0.1 M Zn(NO3)2 was added to the electrolyte to discourage dissolution of the Prussian Blue analogues. Electrolytes were unbuffered neutral solutions with pH of approximately 6-7. In some cases, NaClO4 was substituted for NaNO3.

Electrochemical Characterization of Hexacyanomanganate-Based Anodes

Half-cell measurements were performed on hexacyanomanganate-based Prussian Blue analogue anodes. The cell contained the working electrode, a Ag/AgCl reference electrode, an activated charcoal counter electrode, and an aqueous, deaerated electrolyte. Cyclic voltammetry and galvanostatic cycling scans were performed on the working electrodes.

As illustrated in FIG. 2, both ZnHCMn and MnHCMn undergo two electrochemical reactions at low potentials. This result is consistent with those previously reported for CrHCMn and iron hexacyanomanganate (FeHCMn). As the presence of two reactions is independent of the identity of the P-site cation, both reactions are due to electrochemical activity of the hexacyanomanganate group.

The upper reaction corresponds to the reduction of Mn3+ to Mn2+, while the lower reaction corresponds to the reduction of Mn2+ to Mn+. Though +1 is a rarely observed valence state for manganese, it has been previously observed in hexacyanomanganate complexes, for example see Griffith, W. P. Cyanide Complexes Of The Early Transition Metals (Groups IVa-VIIa). Coord. Chem. Rev., 17, 177 (1975).

In a 1 M NaNO3 electrolyte, the standard potentials of ZnHCMn were found to be −0.57 V and +0.28 V vs. the standard hydrogen electrode (SHE). The standard potentials of ZnHCMn were found to be −0.52 V and +0.32 V vs. SHE in a 1 M KNO3 electrolyte as illustrated in FIG. 4. The initial open circuit potential of ZnHCMn was about 0.65 V vs. SHE, above its upper reaction. This is consistent with the initial Mn3+ state.

The standard potentials of the reactions of MnHCMn with Na+ were found to be −0.76 V and 0.04 V vs. SHE. These values are consistent with those previously reported for its reaction with K+. The reaction potentials of MnHCMn were found to be independent of the synthesis method. Materials synthesized from Mn2+ and [Mn(CN)6]3− precursors or one-step synthesis from Mn2+ and KCN both showed the same electrochemical behavior. The only difference was the initial charge state: MnHCMn (and ZnHCMn) synthesized from a [Mn(CN)6]3− precursor contained Mn3+ and had a high initial potential, whereas MnHCMn synthesized by the one-step synthesis method contained only Mn2+, resulting in an initial potential between its two electrochemical reactions.

In pH-neutral aqueous electrolytes that contain concentrated salts, water is stable against reduction to hydrogen gas above a potential of about −0.5 V vs. SHE. The position of this lower limit for the stability of water depends on the pH and the concentration of the salts present. The stability of the electrolyte places a limit on the lowest potential at which an anode can practically operate. For example, the lower reaction potential of MnHCMn (−0.76 V) is below the potential for the onset of H2 gas production in high purity water. This means that the lower reaction potential of MnHCMn cannot be used in aqueous electrolytes during battery cycling, as rapid H2 generation will occur before the anode can be charged to a low enough potential as illustrated in FIG. 5a. Side reactions such as H2 production drastically lower the charge efficiency of the anode, which can result in overcharging of the cathode and battery failure. In addition, pressure buildup in a battery due to gas generation can lead to catastrophic battery fires and explosions.

Though the use of a basic electrolyte would result in a lower potential for the onset of H2 generation, Prussian Blue analogues rapidly decompose at high pH. Mildly acidic or neutral electrolytes are needed for them to be stable. Thus, only the upper reaction of MnHCMn can be used without deleterious H2 production. As the upper stability limit of these aqueous electrolytes is near 1 V, MnHCMn can be paired with a cathode such as CuHCF to produce a battery with an average full cell voltage of about 0.9-1 V as illustrated in FIG. 5a. This is a useful voltage that is only slightly lower than those of commercial nickel-metal hydride cells.

However, the energy stored in a battery scales linearly with voltage, and the power output of a battery scales with the square of its voltage. Therefore, when the lower reaction of a hexacyanomanganate-based Prussian Blue analogue can be used, the resulting increase in battery voltage has enormous implications for the energy and power of the battery as illustrated in FIG. 5b. Of the previously-known hexacyanomanganate-based Prussian Blue analogues, only CrHCMn has high enough reaction potentials for its lower reaction to be useful as a battery anode. Unfortunately, as discussed above, the rapid hydrolysis of the Cr2+ precursor used during production of CrHCMn makes its phase pure synthesis challenging. As no other previously documented hexacyanomanganate-based Prussian Blue analogue has a high enough lower potential, embodiments of the present invention demonstrate a new material with a suitable lower reaction potential that can be readily produced in bulk with high purity.

It has been previously observed that the electrochemical potentials of the hexacyanometalate groups in Prussian Blue analogues are typically higher in those materials that contain smaller, more highly charged nitrogen-coordinated P-site metal cations. Scholz, F., et al. The Formal Potentials of Solid Metal Hexacyanometalates. Angew. Chem. Int. Ed. Engl., 34, 2685 (1995). In other words, Prussian Blue analogues with smaller lattice parameters typically have higher reaction potentials. For instance, the CuHCF cathode has a smaller lattice parameter and higher reaction potential than the nickel hexacyanoferrate (NiHCF) cathode. Wessells, C. D., et al. Tunable Reaction Potentials in Open Framework Nanoparticle Battery Electrodes for Grid-Scale Energy Storage. ACS Nano, 6, 1688 (2012).

It was predicted by the inventors that ZnHCMn, a material previously unknown to scientific and patent literature, would have a lower reaction potential that is high enough for it to be used in aqueous electrolytes for the operation of the anode. The ionic radius of Cr2+(low spin) is 87 pm (10-12 m), while the ionic radius of Mn2+ (high spin) is 97 pm. These radii, along with the higher reaction potentials of CrHCMn than of MnHCMn, match the general trend described above. The ionic radius of Zn2+ is 88 pm. Therefore, from the relatively small ionic radius of Zn2+, the reaction potentials of ZnHCMn were predicted to be significantly higher than those of MnHCMn. As described above, this result was indeed found to be the case.

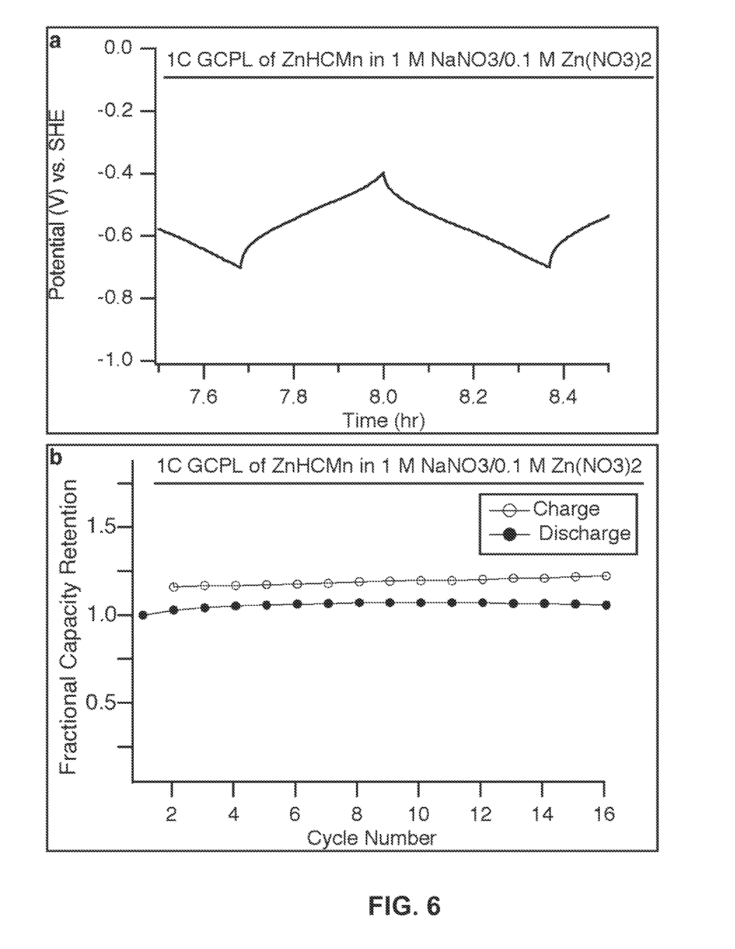

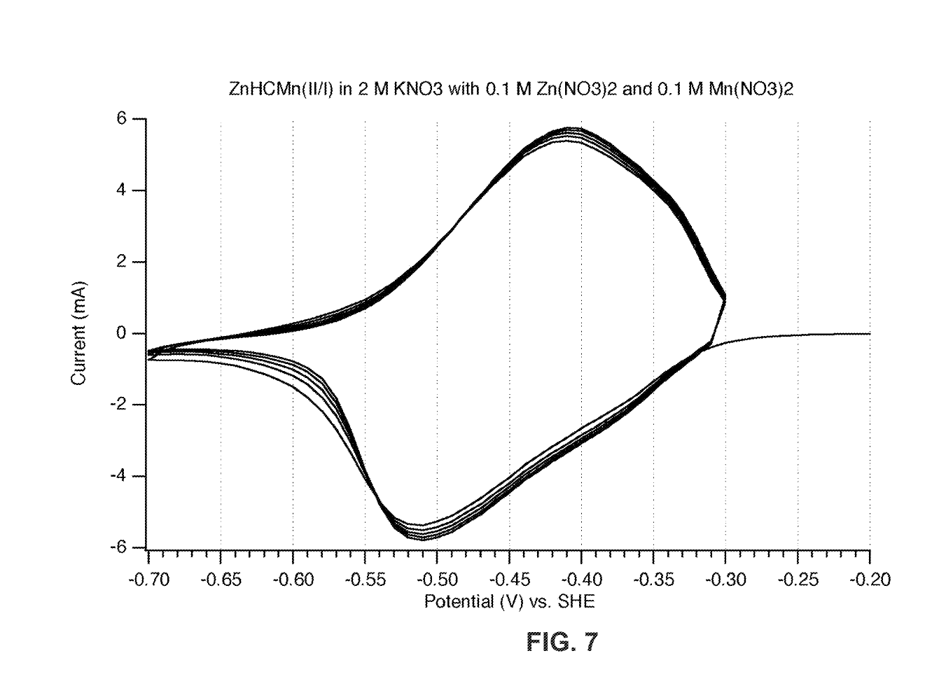

The lower standard potential of ZnHCMn, at about −0.5 V, is illustrated in FIG. 5b. While this is below the potential for the onset of H2 gas generation in pure water, it is high enough for efficient, highly reversible cycling as illustrated in FIG. 6 in the aqueous electrolyte. From the Nernst Equation, the reaction potential of ZnHCMn is dependent on the salt concentration in the electrolyte. The use of more concentrated salts such as saturated NaNO3 or NaClO4 (8-12 M) or 2 M KNO3 raises the lower reaction potential of ZnHCMn to about −0.45 V as illustrated in FIG. 7. This further improves the coulombic efficiency of the ZnHCMn anode.

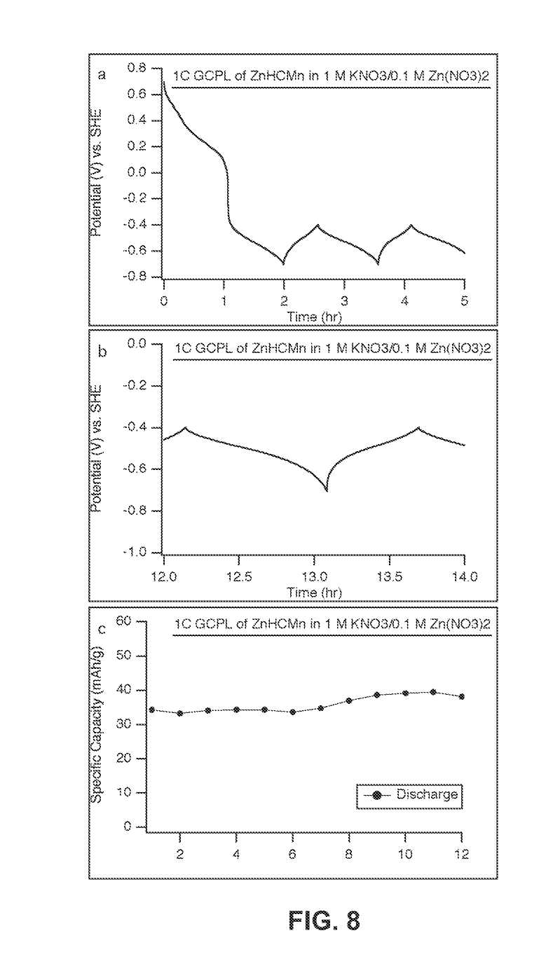

Together, the results of X-ray diffraction analysis and electrochemical characterization of the upper reaction show that ZnHCMn can be readily synthesized with high purity. X-ray diffraction found only trace impurities in ZnHCMn synthesized in anaerobic conditions as illustrated in FIG. 3. Electrochemical characterization of ZnHCMn found a specific capacity of about 60 mAh/g (1 hour at a 1C rate of 60 mA/g) for the upper reaction illustrated in FIG. 8a. The full specific capacity of the lower reaction cannot be accurately measured due to the onset of H2 generation at extremely low potentials illustrated in FIG. 8a-FIG. 8c. Initial tests showed specific discharge capacities of 35-45 mAh/g for the lower reaction, with some variation between samples. Further optimization of the ZnHCMn anode will increase its useful specific capacity; however, it is already high enough for its practical use. A variety of Prussian Blue analogues have already been shown to have specific capacities of about 60 mAh/g.

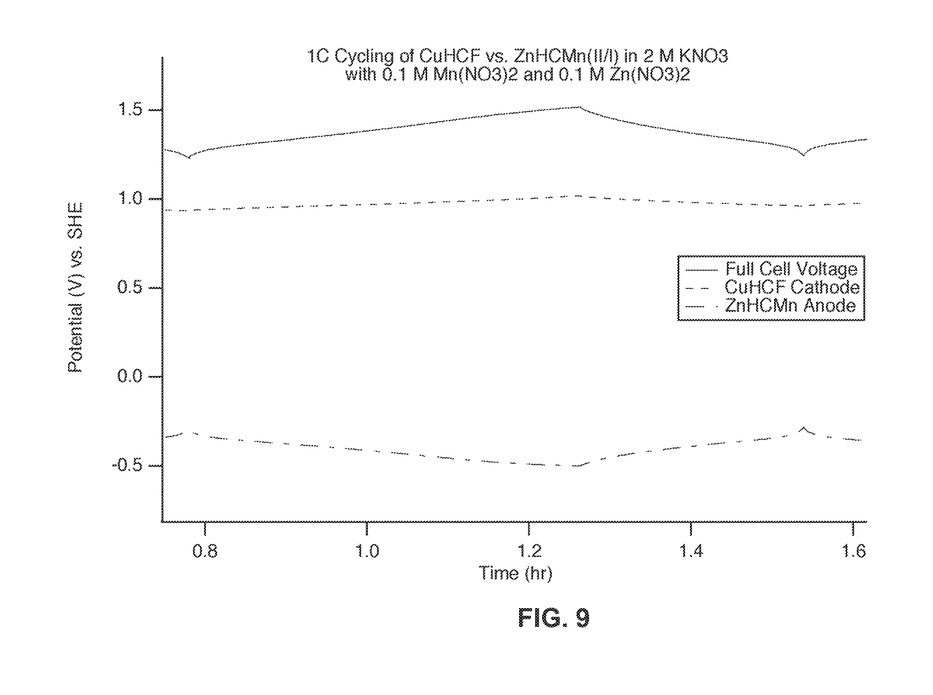

Full batteries were constructed using a ZnHCMn anode, a CuHCF cathode, and a 2 M KNO3 electrolyte that also contained 0.1 M Mn(NO3)2 and 0.1 M Zn(NO3)2. Galvanostatic cycling of this battery is illustrated in FIG. 9. For this purpose a reference electrode was used to limit the potential range of the ZnHCMn anode and avoid excessive H2 generation, while an excess of CuHCF was used to avoid O2 generation at high potential. Simple improvements in battery design such as optimization of pH with a buffered electrolyte and complete removal of oxygen from the cell will further improve the performance of this battery.

Nevertheless, the battery shown here represents the first aqueous electrolyte battery using Prussian Blue analogues as both anode and cathode with an operational voltage over one volt. Previous cells used solid electrolytes such as Nafion, an anode with a high reaction potential based on hexacyanoferrate or hexacyanoruthenate, or both.

Further improvement of the ZnHCMn anode will be achieved by raising its reaction potentials through chemical substitutions with additional transition metals (as in the case of cathodes, as explained in Wessells, C. D., et al. Tunable Reaction Potentials in Open Framework Nanoparticle Battery Electrodes for Grid-Scale Energy Storage. ACS Nano, 6, 1688 (2012). For example, the addition of some chromium to the structure would raise its potential further, and if only a small amount of chromium is initially present, the Cr2+ hydrolysis side reaction would not result in large quantities of impurity phases. Other metal cations with small ionic radii, and therefore, that can raise the electrochemical reaction potentials of ZnHCMn include Cu2+, Ni2+, Co2+, Ti3+, V3+, and Al3+, among many others.

Those metal cations that are electrochemically stable against reduction at the operational potentials of the anode containing them are most desirable. For example, the standard potential for reduction of Cu2+ to Cu0 is +0.34 V vs. SHE, significantly higher than the operational potential of hexacyanomanganate-based Prussian Blue analogues. Thus if copper hexacyanomanganate (CuHCMn) were used as an anode with a low operational potential, the Cu2+ would be at risk of reduction to Cu0, leaving free Mn(CN)64− anions to dissolve or hydrolyze. In fact, during the course of the work reported here, CuHCMn was synthesized using the same procedure as was used for the production of ZnHCMn. The electrochemical activity of CuHCMn was found to rapidly decay, indicating that the material was unstable at low potentials. However, the choice of zinc in ZnHCMn is particularly advantageous, as both reaction potentials of ZnHCMn are above the reduction potential of Zn2+ to ZnO.

In a similar way, larger P-site cations can be used to lower the reaction potentials of Prussian Blue analogues. This allows a higher-voltage battery to be constructed in which the upper reaction of the hexacyanomanganate groups is used for the electrochemical activity of the anode. For example, the relatively large radius of high spin Fe2+ results in low reaction potentials for FeHCMn that are comparable to MnHCMn. Other large metal cations such as V2+, Pd2+, and Pb2+ can all be used to lower the reaction potentials of Prussian Blue analogues. Using the logic outlined here, a vanadium(II) hexacyanomanganate, for example, would have somewhat lower reaction potentials than MnHCMn. If its upper reaction were used as an anode, then a full battery also containing a CuHCF cathode would have a voltage higher than the 0.9 V achievable in a MnHCMn/CuHCF cell.

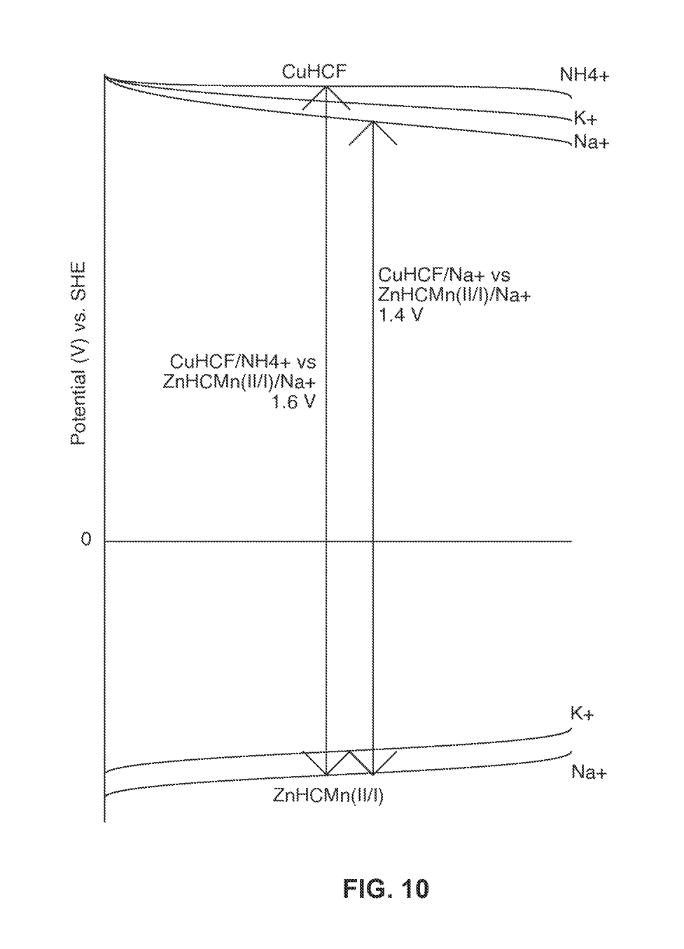

It should be noted that the reaction potentials of Prussian Blue analogues depend on the identity of the insertion species. This was previously shown for a variety of hexacyanoferrate-based cathodes, see Wessells, C. D., et al. The Effect of Insertion Species on Nanostructured Open Framework Hexacyanoferrate Battery Electrodes. J. Electrochem. Soc., 159, A98 (2012). For example, the reaction potential of CuHCF with NH4+ is higher than its reaction with K+, which in turn is higher than its reaction with Na+. In these embodiments, the potentials of ZnHCMn were found to be higher during reaction with K+ than with Na+. Using this principle, a higher battery voltage can be achieved when the two Prussian Blue analogue electrodes react with different insertion species as illustrated in FIG. 10. For example, in a battery containing a ZnHCMn anode and a CuHCF cathode that start at states of full charge, and in which the electrolyte contains both Na+ and K+, the discharge (oxidation) of the anode will proceed by the extraction of Na+, while the discharge (reduction) of the cathode will proceed by the insertion of K+. Na+ is extracted from the anode at a lower potential than K+ is, and K+ is inserted into the cathode at a higher potential than Na+ is, so these two mechanisms will dominate the discharge process, resulting in a higher full cell battery voltage than what could be achieved using only K+ or Na+ illustrated in FIG. 9. This effect could be further magnified by using NH4+ as the insertion species for the CuHCF cathode. An increase in full cell voltage of up to 0.1-0.2 V is possible by using two different insertion ions for the anode and cathode.

The following references provide background information that may assist the reader in understanding some of the context of the discussion herein. These references are hereby expressly incorporated by reference in their entireties for all purposes:

1. Rastler, D. Electricity Energy Storage Technology Options, Electric Power Research Institute, 1020676 (2010).

2. Wessells, C. D., et al. Copper hexacyanoferrate battery electrodes with long cycle life and high power. Nature Comm., 2, 550 (2011).

3. Wessells, C. D., et al. Nickel Hexacyanoferrate Nanoparticle Electrodes for Aqueous Sodium and Potassium Ion Batteries. Nano Lett., 11, 5421 (2011).

4. Wessells, C. D., et al. The Effect of Insertion Species on Nanostructured Open Framework Hexacyanoferrate Battery Electrodes. J. Electrochem. Soc., 159, A98 (2012).

5. Wessells, C. D., et al. Tunable Reaction Potentials in Open Framework Nanoparticle Battery Electrodes for Grid-Scale Energy Storage. ACS Nano, 6, 1688 (2012).

6. Pasta, M., et al. A high-rate and long cycle life aqueous electrolyte battery for grid-scale energy storage. Nature Comm., 3, 1149 (2012).

7. Buser, H. J., et al. The Crystal Structure of Prussian Blue: Fe4[Fe(CN)6]3.xH2O. Inorg. Chem., 16, 2704 (1977).

8. Itaya, K., et al. Electrochemistry of Polynuclear Transition Metal Cyanides: Prussian Blue and Its Analogues. Acc. Chem. Res., 19, 162 (1986).

9. Messina, R., Perichon, J., and Broussely, M. Mécanismes de la réduction electrochimique en milieu non aqueux de materiaux cathodiques utilizes dans les piles au lithium. IV. Réduction d'électrodes membranaires d'hexacyanoferrates (II et III) d′argent dans le mélange carbonate de propylene-1,2-diméthoxyéthane. J. Appl. Electrochem., 9, 677 (1979).

10. Messina, R., and Perichon, J. Mécanisme de la réduction électrochimique en milieu non aqueux de materiaux cathodiques utilizes dan les piles au lithium. V. Utilisation des hexacyanoferrates de fer (II et III) comme materiaux cathodiques reversibles. J. Appl. Electrochem., 10, 655 (1980).

11. Neff, V. D. Some Performance Characteristics of a Prussian Blue Battery. J. Electrochem. Soc., 132, 1382 (1985).

12. Honda, K. and Hayashi, H. Prussian Blue Containing Nafion Composite Film as Rechareable Battery. J. Electrochem. Soc., 134, 1339 (1987).

13. Grabner, E. W., and Kalwellis-Mohn, S. Hexacyanoferrate layers as electrodes for secondary cells. J. Appl. Electrochem., 17, 653 (1987).

14. Kaneko, M., and Okada, T. A secondary battery composed of multilayer Prussian Blue and its reaction characteristics. J. Electroanal. Chem., 255, 45 (1988).

15. Kalwellis-Mohn, S., and Grabner, E. W. A Secondary Cell Based on Thin Film Layers of Zeolite-Like Nickel Hexacyanometallates. Electrochim. Acta., 34, 1265 (1989).

16. Jayalakshmi, M., and Scholz, F. Charge-discharge characteristics of a solid-state Prussian blue secondary cell. J. Power Sources, 87, 212 (2000).

17. Jayalakshmi, M., and Sholz, F. Performance characteristics of zinc hexacyanoferrate/Prussian blue and copper hexacyanoferrate/Prussian blue soid state secondary cells. J. Power Sources, 91, 217 (2000).

18. Itaya, K., et al. European Patent Application EP 0086555A1 (Jan. 13, 1983).

19. Eftekhari, A. Fabrication of all-solid-state thin-film secondary cells using hexacyanometalate-based electrode materials. J. Power Sources, 132, 291 (2004).

20. Okubo, M., et al. Switching Redox-Active Sites by Valence Tautomerism in Prussian Blue Analaogues AxMny[Fe(CN)6].nH2O (A: K, Rb): Robust Frameworks for Reversible Li Storage. J. Phys. Chem. Lett., 1, 2063 (2010).

21. Asakura, D., et al. Fabrication of a Cyanide-Bridged Coordination Polymer Electrode for Enhanced Electrochemical Ion Storage Ability. J. Phys. Chem. C, 116, 8364 (2012).

22. López-Cueto, G., et al. Fast disproportionation of hexacyanomanganate(III) in acidic solution. Formation of hexacyanomanganate(IV) and kinetics of its decomposition. Can. J. Chem., 64, 2301 (1986).

23. Scholz, F., et al. The Formal Potentials of Solid Metal Hexacyanometalates. Angew. Chem. Int. Ed. Engl., 34, 2685 (1995).

24. Griffith, W. P. Cyanide Complexes Of The Early Transition Metals (Groups IVa-VIIa). Coord. Chem. Rev., 17, 177 (1975).

25. Casado, J., et al. Photogalvanic Behavior Of K3Mn(CN)6 In CN— Aqueous Solutions. Electrochim. Acta., 35, 427 (1990).

26. Clauss, V. D., et al. Über Hexacyanomanganate(I) and Hexacyanorenat(I), Z. Anorg. Allg. Chem., 297, 300 (1958).

27. Schwochau, V. K., et al. Darstellung and Eigenschaften von Kalium-cyanotechnetat(I), Z. Anorg. Allg. Chem., 319, 148 (1962).

28. Shannon, R. D. Revised Effective Ionic Raddi and Systematic Studies of Interatomic Distances in Halides and Chalcogenides, Acta Cryst., A32, 751 (1976).

The system and methods above have been described in general terms as an aid to understanding details of preferred embodiments of the present invention. In the description herein, numerous specific details are provided, such as examples of components and/or methods, to provide a thorough understanding of embodiments of the present invention. Some features and benefits of the present invention are realized in such modes and are not required in every case. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. An electrochemical apparatus, comprising:
an aqueous electrolyte including a quantity of water and a plurality of ions with said aqueous electrolyte decomposing to oxygen gas at a first potential and decomposing to hydrogen gas at a second potential; and
a first electrode disposed in said aqueous electrolyte, said first electrode including a first Prussian Blue analogue material having a general chemical formula AₓP_{y}[R(CN)₆₋ⱼLⱼ]_{z}.nH₂O, where: A is a cation, P is a metal cation, R is a transition metal cation, and L is a ligand substitutable in the place of a CN⁻ ligand, and 0≦j≦6, 0≦x≦2, 0≦y≦4, 0<z≦1, and 0≦n≦5, wherein said first Prussian Blue analogue material has a first specific chemical formula conforming to said general chemical formula, wherein said first specific chemical formula includes a first particular hexacyanometalate group (R(CN)₆₋ⱼLⱼ) with a first R cation, and wherein said first particular hexacyanometalate group (R(CN)₆₋ⱼLⱼ) is configured to be electrochemically active having a first redox reaction of said first R cation from a first valence state of said first R cation to a second valence state of said first R cation at a first redox potential and having a second redox reaction of said first R cation between said second valence state of said first R cation and a third valence state of said first R cation at a second redox potential wherein both said redox potentials are between said first potential and said second potential.

2. The electrochemical apparatus of claim 1 wherein said general chemical formula includes:
A is one or more cations selected from the group consisting of Na⁺, K⁺, Li⁺, NH₄⁺, Mg2⁺, or Ca2⁺ and combinations thereof;
P is one or more metal cations selected from the group consisting of V²⁺, V³⁺, Cr²⁺, Cr³⁺, Mn²⁺, Mn³⁺, Fe²⁺, Fe³⁺, Co²⁺, Co³⁺, Ni²⁺, Cu⁺, Cu²⁺, Zn²⁺, Al³⁺, Sn²⁺, In³⁺, or Pb²⁺ and combinations thereof;
R is one or more transition metal cations selected from the group consisting of V²⁺, V³⁺, Cr²⁺, Cr³⁺, Mn⁺, Mn²⁺, Mn³⁺, Fe²⁺, Fe³⁺, Co²⁺, Co³⁺, Ru²⁺, Ru³⁺, Os²⁺, Os³⁺, Ir²⁺, Ir³⁺, Pt²⁺, or Pt³⁺ and combinations thereof; and
L is one or more ligands that may be substituted in the place of a CN⁻ ligand selected from the group consisting of CO (carbonyl), NO (nitrosyl), or Cl⁻ and combinations thereof.

3. The electrochemical apparatus of claim 1 wherein said first particular hexacyanometalate group (R(CN)₆₋ⱼLⱼ) includes manganese (Mn) as said first R cation.

4. The electrochemical apparatus of claim 3 wherein said first valence state of said first R cation includes Mn³⁺, said second valence state of said first R cation includes Mn²⁺, and said third valence state of said first R cation includes Mn⁺.

5. The electrochemical apparatus of claim 4 wherein said first electrode is configured as an anode and further comprising a second electrode configured as a cathode disposed in said aqueous electrolyte, said second electrode including a second Prussian Blue analogue material having said general chemical formula, wherein said second Prussian Blue analogue material has a second specific chemical formula conforming to said general chemical formula different from said first specific chemical formula, wherein said electrodes and said electrolyte are configured as a rechargeable battery including a discharge reaction and a charge reaction, and wherein said first particular hexacyanometalate group (R(CN)₆₋ⱼLⱼ) is configured to be electrochemically active during said discharge reaction and said charge reaction.

6. The electrochemical apparatus of claim 5 wherein said anode is electrochemically active using said second redox reaction.

7. The electrochemical apparatus of claim 5 wherein said cathode includes a second particular hexacyanometalate group (R(CN)₆₋ⱼLⱼ) with a second R cation including iron (Fe).

8. The electrochemical apparatus of claim 1 wherein said first electrode is configured as an anode and further comprising a second electrode configured as a cathode disposed in said aqueous electrolyte, said second electrode including a second Prussian Blue analogue material having said general chemical formula, wherein said second Prussian Blue analogue material has a second specific chemical formula conforming to said general chemical formula different from said first specific chemical formula, wherein said electrodes and said electrolyte are configured as a rechargeable battery including a discharge reaction and a charge reaction, and wherein said first particular hexacyanometalate group (R(CN)₆₋ⱼLⱼ) is configured to be electrochemically active during said discharge reaction and said charge reaction.

9. The electrochemical apparatus of claim 8 wherein said anode is electrochemically active using said second redox reaction.

10. The electrochemical apparatus of claim 1 wherein a first particular one of said plurality of ions is configured to intercalate said first electrode during an operation of said electrode in said aqueous electrolyte wherein said first particular one of said plurality of ions has a concentration greater than 1 M in said aqueous electrolyte.

11. The electrochemical apparatus of claim 1 wherein said aqueous electrolyte includes an electrolyte pH within a range of 4-8.

12. The electrochemical apparatus of claim 1 wherein said plurality of ions includes a first plurality ions of said P cation and a second plurality of ions of said first R cation.

13. A rechargeable battery, comprising:
an aqueous electrolyte including a quantity of water and a plurality of ions with said aqueous electrolyte decomposing to oxygen gas at a first potential and decomposing to hydrogen gas at a second potential; and
a first electrode disposed in said aqueous electrolyte, said first electrode configured as an anode and including a first Prussian Blue analogue material having a general chemical formula AₓP_{y}[R(CN)₆₋ⱼLⱼ]_{z}.nH₂O, where: A is a cation, P is a metal cation, R is a transition metal cation, and L is a ligand substitutable in the place of a CN⁻ ligand, and 0≦j≦6, 0≦x≦2, 0<y≦4, 0<z≦1, and 0≦n≦5, wherein said first Prussian Blue analogue material has a first specific chemical formula conforming to said general chemical formula, wherein said first specific chemical formula includes a first particular hexacyanometalate group (R(CN)₆₋ⱼLⱼ) with a first R cation, and
wherein said first particular hexacyanometalate group (R(CN)₆₋ⱼLⱼ) is configured to be electrochemically active having a first redox reaction of said first R cation from a first valence state of said first R cation to a second valence state of said first R cation at a first redox potential and having a second redox reaction of said first R cation between said second valence state of said first R cation and a third valence state of said first R cation at a second redox potential wherein both said redox potentials are between said first potential and said second potential; and
a second electrode disposed in said aqueous electrolyte, said second electrode configured as a cathode and including a second Prussian Blue analogue material having said general chemical formula, wherein said second Prussian Blue analogue material has a second specific chemical formula conforming to said general chemical formula different from said first specific chemical formula, wherein said second chemical formula includes a second particular hexacyanometalate group (R(CN)₆₋ⱼLⱼ) with a second R cation different from said first R cation, and wherein said second particular hexacyanometalate group (R(CN)₆₋ⱼLⱼ) is configured to be electrochemically active having a cathode redox reaction of said second R cation from a first valence state of said second R cation to a second valence state of said second R cation at a cathode redox potential wherein said cathode redox potential is between said first potential and said second potential.

14. The rechargeable battery of claim 13 wherein a difference between said cathode redox potential and said second redox potential is greater than 1.0 volt.

15. An electrochemical apparatus, comprising:
an aqueous electrolyte including a quantity of water and a plurality of ions with said aqueous electrolyte including a first potential at which an electrolysis of said aqueous electrolyte begins a generation of an excessive quantity of hydrogen gas; and
a first electrode disposed in said aqueous electrolyte, said first electrode including a first Prussian Blue analogue material having a general chemical formula AₓP_{y}[R(CN)₆₋ⱼLⱼ]_{z}.nH₂O, where: A is a cation, P is a metal cation, R is a transition metal cation, and L is a ligand substitutable in the place of a CN⁻ ligand, and 0≦j≦6, 0≦x≦2, 0<y≦4, 0<z≦1, and 0≦n≦5, wherein said first Prussian Blue analogue material has a first specific chemical formula conforming to said general chemical formula, wherein said first specific chemical formula includes a first particular hexacyanometalate group (R(CN)₆₋ⱼLⱼ) with a first R cation, and wherein said first particular hexacyanometalate group (R(CN)₆₋ⱼLⱼ) is configured to be electrochemically active having a first redox reaction of said first R cation from a first valence state of said first R cation to a second valence state of said first R cation at a first redox potential and having a second redox reaction of said first R cation between said second valence state of said first R cation and a third valence state of said first R cation at a second redox potential wherein both said redox potentials are above said first potential.

16. A manufacturing method for an electrode of an electrochemical apparatus including an aqueous electrolyte including a quantity of water and a plurality of ions with the aqueous electrolyte decomposing to oxygen gas at a first potential and decomposing to hydrogen gas at a second potential, comprising:
(a) synthesizing a first Prussian Blue analogue material with a general chemical formula AₓP_{y}[R(CN)₆₋ⱼLⱼ]_{z}.nH₂O, where: A is a cation, P is a metal cation, R is a transition metal cation, and L is a ligand substitutable in the place of a CN⁻ ligand, and 0≦j≦6, 0≦x≦2, 0<y≦4, 0<z≦1, and 0≦n≦5 wherein said first Prussian Blue analogue material has a first specific chemical formula conforming to said general chemical formula, wherein said first specific chemical formula includes a first particular hexacyanometalate group (R(CN)₆₋ⱼLⱼ) with a first R cation, wherein said first R cation is selected to configure said first particular hexacyanometalate group (R(CN)₆₋ⱼLⱼ) to be electrochemically active having a first redox reaction of the first R cation from a first valence state of the first R cation to a second valence state of the first R cation at a first redox potential and having a second redox reaction of the first R cation between said second valence state of the first R cation and a third valence state of the first R cation at a second redox potential wherein both said redox potentials are between the first potential and the second potential; and
(b) forming the electrode from said first Prussian Blue analogue material.

17. The manufacturing method of claim 16 wherein said first R cation includes manganese (Mn).

18. A method for operating a rechargeable battery, comprising:
(a) disposing a first electrode and a second electrode in an aqueous electrolyte, said aqueous electrolyte including a quantity of water and a plurality of ions with said aqueous electrolyte decomposing to oxygen gas at a first potential and decomposing to hydrogen gas at a second potential wherein said first electrode is configured as an anode and includes a first Prussian Blue analogue material having a general chemical formula AₓP_{y}[R(CN)₆₋ⱼLⱼ]_{z}.nH₂O, where: A is a cation, P is a metal cation, R is a transition metal cation, and L is a ligand substitutable in the place of a CN⁻ ligand, and 0≦j≦6, 0≦x≦2, 0<y≦4, 0<z≦1, and 0≦n≦5, wherein said first Prussian Blue analogue material has a first specific chemical formula conforming to said general chemical formula, wherein said first specific chemical formula includes a first particular hexacyanometalate group (R(CN)₆₋ⱼLⱼ) with a first R cation, and wherein said first particular hexacyanometalate group (R(CN)₆₋ⱼLⱼ) is configured to be electrochemically active having a first redox reaction of said first R cation from a first valence state of said first R cation to a second valence state of said first R cation at a first redox potential and having a second redox reaction of said first R cation between said second valence state of said first R cation and a third valence state of said first R cation at a second redox potential wherein both said redox potentials are between said first potential and said second potential, and wherein said second electrode is configured as a cathode and includes a second Prussian Blue analogue material having said general chemical formula, wherein said second Prussian Blue analogue material has a second specific chemical formula conforming to said general chemical formula different from said first specific chemical formula, wherein said second chemical formula includes a second particular hexacyanometalate group (R(CN)₆₋ⱼLⱼ) with a second R cation different from said first R cation, and wherein said second particular hexacyanometalate group (R(CN)₆₋ⱼLⱼ) is configured to be electrochemically active having a cathode redox reaction of said second R cation from a first valence state of said second R cation to a second valence state of said second R cation at a cathode redox potential wherein said cathode redox potential is between said first potential and said second potential and greater than said second redox potential; and
(b) storing energy using said second redox reaction and said cathode redox reaction; and
(c) extracting energy using said second redox reaction and said cathode redox reaction.

19. The manufacturing method of claim 18 wherein said first R cation includes manganese (Mn).

20. A method for tuning a redox potential of an electrode to be disposed in an aqueous electrolyte including a quantity of water and a plurality of ions with the aqueous electrolyte decomposing to oxygen gas at a first potential and decomposing to hydrogen gas at a second potential, comprising:
(a) synthesizing a first Prussian Blue analogue material with a general chemical formula AₓP_{y}[R(CN)₆₋ⱼLⱼ]_{z}.nH₂O, where: A is a cation, P is a metal cation, R is a transition metal cation, and L is a ligand substitutable in the place of a CN⁻ ligand, and 0≦j≦6, 0≦x≦2, 0<y≦4, 0<z≦1, and 0≦n≦5 wherein said first Prussian Blue analogue material has a first specific chemical formula conforming to said general chemical formula, wherein said first specific chemical formula includes a first particular P cation and a first particular hexacyanometalate group (R(CN)₆₋ⱼLⱼ) with a first R cation, wherein said first Prussian Blue analogue material has an initial redox reaction that is lower than said second potential;
(b) synthesizing a second Prussian Blue analogue material with said general chemical formula wherein said second Prussian Blue analogue material has a second specific chemical formula conforming to said general chemical formula different from said first specific chemical formula, wherein said second specific chemical formula modifies said first specific chemical formula to include a second particular P cation different from said first particular P cation while including said first particular hexacyanometalate group (R(CN)₆₋ⱼLⱼ) with said first R cation, wherein said second Prussian Blue analogue material has a tuned redox reaction that is greater than said second potential; and
(c) forming the electrode from said second Prussian Blue analogue material.

21. The tuning method of claim 20 wherein said first particular hexacyanometalate group (R(CN)₆₋ⱼLⱼ) is configured to be electrochemically active having a first redox reaction of said first R cation from a first valence state of said first R cation to a second valence state of said first R cation at a first redox potential and having a second redox reaction of said first R cation between said second valence state of said first R cation and a third valence state of said first R cation at a second redox potential wherein both said redox potentials are between said first potential and said second potential and wherein said initial redox reaction and said tuned redox reaction correspond to said second redox reaction.

22. The tuning method of claim 21 wherein said first R cation includes manganese (Mn).

23. A method for tuning a redox potential of an electrode to be disposed in an aqueous electrolyte including a quantity of water and a plurality of ions with the aqueous electrolyte decomposing to oxygen gas at a first potential and decomposing to hydrogen gas at a second potential, comprising:
(a) synthesizing a first Prussian Blue analogue material with a general chemical formula AₓP_{y}[R(CN)₆₋ⱼLⱼ]_{z}.nH₂O, where: A is a cation, P is a metal cation, R is a transition metal cation, and L is a ligand substitutable in the place of a CN— ligand, and 0≦j≦6, 0≦x≦2, 0<y≦4, 0<z≦1, and 0≦n≦5 wherein said first Prussian Blue analogue material has a first specific chemical formula conforming to said general chemical formula, wherein said first specific chemical formula includes a first particular P cation and a first particular hexacyanometalate group (R(CN)₆₋ⱼLⱼ) with a first R cation, wherein said first Prussian Blue analogue material has an initial redox reaction between the first potential and the second potential;
(b) synthesizing a second Prussian Blue analogue material with said general chemical formula wherein said second Prussian Blue analogue material has a second specific chemical formula conforming to said general chemical formula different from said first specific chemical formula, wherein said second specific chemical formula modifies said first specific chemical formula to include a second particular P cation different from said first particular P cation while including said first particular hexacyanometalate group (R(CN)₆₋ⱼLⱼ) with said first R cation, wherein said second Prussian Blue analogue material has a tuned redox reaction that is lower than said initial redox reaction and greater than said second potential; and
(c) forming the electrode from said second Prussian Blue analogue material.

24. The tuning method of claim 23 wherein said first particular hexacyanometalate group (R(CN)₆₋ⱼLⱼ) is configured to be electrochemically active having a first redox reaction of said first R cation from a first valence state of said first R cation to a second valence state of said first R cation at a first redox potential and having a second redox reaction of said first R cation between said second valence state of said first R cation and a third valence state of said first R cation at a second redox potential wherein both said redox potentials are between said first potential and said second potential and wherein said initial redox reaction and said tuned redox reaction correspond to said first redox reaction.

25. The tuning method of claim 24 wherein said first R cation includes manganese (Mn)

26. The tuning method of claim 23 wherein said first particular hexacyanometalate group (R(CN)₆₋ⱼLⱼ) in said first chemical formula is configured to be electrochemically active having a first redox reaction of said first R cation from a first valence state of said first R cation to a second valence state of said first R cation at a first redox potential and having a second redox reaction of said first R cation between said second valence state of said first R cation and a third valence state of said first R cation at a second redox potential, wherein said first particular hexacyanometalate group (R(CN)₆₋ⱼLⱼ) in said second chemical formula is configured to be electrochemically active having a third redox reaction of said first R cation from a first valence state of said first R cation to a second valence state of said first R cation at a third redox potential different from said first redox potential and having a fourth redox reaction of said first R cation between said second valence state of said first R cation and a third valence state of said first R cation at a fourth redox potential different from said second redox potential,
wherein said first redox potential and said third redox potential are between said first potential and said second potential, wherein said initial redox reaction corresponds to said first redox reaction, and wherein said tuned redox reaction corresponds to said third redox reaction.

27. The tuning method of claim 26 wherein said fourth redox potential is below said second potential.

28. The tuning method of claim 26 wherein said first R cation includes manganese (Mn).
